(19) United States
(12) Patent Application Publication
(10) Pub. No.: US 2024/0358174 A1
(43) Pub. Date: Oct. 31, 2024

(54) Tasting Glass

(71) Applicant: CRAFT IRISH DISTILLING CO. LIMITED, Dublin (IE)

(72) Inventors: Tiago Russo, Dublin 2 (IE); Katia Martins, Dublin 2 (IE)

(21) Appl. No.: 18/574,580

(22) PCT Filed: Jun. 20, 2022
(86) PCT No.: PCT/GB2022/051566

§ 371 Date: Dec. 27, 2023

(30) Foreign Application Priority Data
Jul. 2, 2021 (GB) GB2109643.3

(51) Int. Cl. A47G 19/22; C03B 11/10; C03C 3/078

(52) U.S. Cl. CPC A47G 19/2205; C03B 11/10; C03C 3/078

(57) ABSTRACT

A tasting glass (1) for consuming high-end alcoholic drinks. The glass is formed from soda-lime glass, has sidewalls (8) which define a volume for accommodating a liquid and a base (2) which is provided with a depression (7). When liquid is poured into the glass the liquid is urged by the depression over a large surface area of the base and sidewalls where any alcoholic content interacts with the soda-lime glass to improve the flavour and/or nose of the drink.

When consuming high-end alcoholic drinks, it is desirable that subtle flavours of the liquid can be tasted. Often these flavours can be overpowered by the ethanol content of the liquid. Equally, it is desirable that the nose of the liquid can be fully appreciated, without the aromas being overpowered by a vaporized ethanol component. This is particularly important for spirits such as whiskey and gin. However, similar considerations apply to the tasting of wine and other alcoholic drinks.

For some drinks it is desirable for the liquid in a glass to be maintained at a specific temperature, to optimize the flavours and/or the nose of the liquid.

It is amongst the objects of the invention to address one or more of these problems.

In a first aspect of the invention there is provided a glass comprising;
sidewalls and a base which define a volume for accommodating a liquid,
wherein a depression is formed in the base,
and wherein the glass is formed from soda-lime glass.

In a further aspect of the invention there is provided a glass comprising;
sidewalls and a base which define a volume for accommodating a liquid,
and wherein the glass is formed from soda-lime glass.

To date, tasting glasses such as whiskey, wine and champagne glasses have invariably been made from crystal glass or borosilicate glass. Crystal glass is also referred to as lead glass. Crystal glass typically contains 18-40% lead oxide. It is preferred for tasting glasses due to its high clarity, consistency and easy workability when heated.

It has however been found that glasses made from soda-lime glass suppress the ethanol burn associated with existing glasses. This is particularly useful for tasting spirits with a high alcohol content such as whiskey. It is thought that the ethanol component of a spirit interacts with the surface structure of the soda-lime glass and is partially adsorbed or absorbed onto/into the surface. This means that less ethanol is available to be vapourised once the liquid has been poured into the glass. This effect may be particularly pronounced when comparing soda-lime glasses according to the invention to borosilicate glasses which have a more sealed surface structure than soda-lime glass. The borosilicate surface is therefore potentially less able to adsorb or absorb the ethanol content.

The composition of the soda-lime glass is also thought to have a beneficial interaction with the ethanol content. The lack of heavy metal ions present in the soda-lime composition (as opposed to the lead ions present in crystal glass) seems to have a beneficial effect on the taste of whiskey.

The presence of these effects depends in part upon the extent to which the liquid can come into contact with the surface of the glass. The base of glass is therefore adapted to modify the way that liquid is distributed as it is poured into the glass (as compared for example to a flat-bottomed glass). The depression in the base of the glass efficiently converts the downwards motion of the liquid as it is poured into the glass into sideways motion up the sidewalls of the glass. The depression is located inside the volume of the glass. The depression redirects liquid efficiently and urges the liquid to run over a greater area of the glass surface. This increases the surface area over which the soda-lime glass can interact with the liquid. The liquid interacts with the glass as a thinner film due to its higher velocity.

It has been found that there is a synergy between the soda-lime glass composition and the depression in the base of the glass, which works to improve the taste and the nose of alcoholic liquids in the glass. The depression also reduces the splash that occurs when liquid is poured into the glass. It is thought that the splashing of a spirit as it is poured could be responsible for vaporizing a noticeable proportion of the ethanol content, which then sits in the glass and detrimentally affects the nose of the drink. The depression therefore allows more of the ethanol content to be retained in the liquid where it is able to interact with the soda-lime composition and be retained in/on the glass rather than in the airspace defined by the volume of the glass (for example the bulb).

Preferably the depression is generally conical. The conical shape of the depression agitates the liquid as it is poured into the glass by creating a tornado or whirlpool-type vortex. This increases the speed of flow the liquid, and thereby enhances the interaction which is has with the surface of the glass. An (inverted) conical depression is also particularly efficient at converting the vertical component of the movement of the liquid into a sideways motion which spreads the liquid around the inside of the glass. Preferably the depression has a curved lower end. This increases the efficiency of the conversion of the vertical component of the movement of the liquid into a sideways motion.

Preferably the depression has a symmetry axis which is perpendicular to the base. This means that the depression provides the effects discussed above, regardless of the direction from which liquid is poured into the glass.

Preferably the depression is centrally located in the base. This means that the depression provides the effects discussed above, regardless of the orientation of the glass. Preferably the depression has a generally conical cross-section, with a curved lower end.

Preferably a volume defined by the depression is between 0.5 ml and 3 ml. Preferably a volume defined by the depression is less than 1 ml. These volumes are particularly advantageous for the volumes of liquids which are commonly poured into the glass when consuming spirits such as whiskey.

Preferably the depth of the depression is between 6 mm and 10 mm, and is preferably around 7.5 mm. Preferably the depth of the depression is greater than 6 mm. These depths are particularly advantageous for the volumes of liquids which are commonly poured into the glass when consuming spirits such as whiskey. These depths may be measured from a generally horizontal portion of the base in which the depression is formed.

Preferably the depression is formed by sidewalls which have a constant curvature. The constant curvature may be at a tangent to the base and lead to a single point concentric to the glass itself. Using constant curvature sidewalls increases the efficiency of the depression.

Preferably the depression comprises sidewalls which have radii of curvature of between about 5 mm and about 20 mm, and preferably between about 10 mm and about 15 mm. Preferably these ranges relate to the tangent aperture radius (see reference numeral 11 relating to the convex curve of the depression's sidewalls in the figures below) of the depression. This provides a depression which is steep enough to create the tornado effect which pushes the liquid towards the side walls effectively (to enhance ethanol adsorption/absorption) but is not steep enough to create air pockets or other unwanted turbulence/splashing.

Preferably the depression has a lower portion which has sidewalls with a concave curve, connected to an upper portion which has sidewalls with a convex curve.

Preferably the base comprises an ice having a thickness of between 20 mm and 50 mm. Preferably the ice of the glass is 30-50 mm thick, more preferably 30-40 mm thick and preferably 40-50 mm thick. The ice of a glass is the single solid volume of glass which sits below the volume for holding the liquid. It has been found that it is particularly easy to form glasses with a thick ice using soda-lime glass, in conjunction with the other features of the glass. Those other features may include the depression in the base of the glass. The thick ice has a high heat capacity and can absorb heat from a user's hand. This is particularly useful for whiskey glasses, where it is preferable for the liquid to be maintained at a constant temperature, whilst being held for a relatively long period by a user. The easily formed thick ice also makes it easier to form the depression during the manufacturing process (discussed below).

This thickness of the ice may be measured from a lower end of the depression to a bottom surface of the glass. Alternatively, the thickness may be measured from a portion of the base of the glass which is not part of the depression (for example a portion which is generally horizontal or parallel to a bottom surface of the glass).

Preferably the sidewalls of the glass form a bulb. Preferably the volume of the glass is between 150 ml and 250 ml, and more preferably between 150 and 180 ml. These volumes are adapted to accommodate 2 drams (1 dram=25-35 ml), allowing half of the remaining space in the bulb for stones and water. These volumes provide plenty of space for the liquid to travel around the sidewalls and for the ethanol to be “thrown” into the glass body.

Preferably the sidewalls have a convergent portion and a divergent portion, wherein the divergent portion forms a mouth of the glass. This configuration creates a neck in the glass to retain the aromas of the drink (e.g., to help to keep the nose of the whiskey strong) whilst the other features of the glass enable this retention to happen without the presence of an overpowering ethanol component.

Preferably, curvature radii of the sidewalls are between 50 mm and 60 mm. Preferably, the glass has an axis of symmetry which is perpendicular to the base of the glass, and preferably infinite planes of symmetry around that axis.

Preferably the glass comprises 65-75% silicon dioxide, 10-20% sodium oxide, and 2-16% calcium oxide.

Preferably the glass comprises about 70% silicon dioxide, about 15% sodium oxide, and about 9 percent calcium oxide.

Preferably the glass comprises about 73% silicon dioxide and about 15% sodium oxide.

Preferably glasses according to the invention comprise substantially no lead oxide, and preferably below 1% or below 0.5% lead oxide.

Preferably, the glass does not contain a borosilicate glass or a crystal glass component which comes into contact with a liquid poured into the glass. Crystal glass is also referred to as lead glass. Crystal glass typically comprises 18-40% lead oxide.

Preferably the glass comprises substantially no barium oxide, or less than 0.2% barium oxide. Preferably the density of the glass is 2.8 g/cm³ or lower and more preferably 2.4 g/cm³ or lower.

Preferably the glass is a spirits glass, for example a whiskey glass.

In a further aspect of the invention there is provided a method of forming a glass as described herein, comprising the steps of;

forming the sidewalls and base of the glass from a heated soda-lime composition, and forming a depression in the base of the glass by imprinting the working end of a tool into the base of the glass.

The sidewalls and base of the glass may be formed from a molten soda-lime composition as described herein. In one embodiment, the heated composition is put into a mould and then blown to form the sidewalls and base of the glass. The glass is then removed from the mould and a tool is inserted through the mouth of the glass. A working end of the tool is imprinted into the base inside the glass whilst the soda-lime material is still hot and malleable. The imprint left by the tool forms the depression in the base of the glass. The glass is then allowed to cool and solidify.

In a further aspect of the invention there is provided a tool for forming a depression in a glass. The tool may comprise a body and a working end, wherein the working end comprises features which correspond to any of the features of the depressions described herein. For example, the tool may have a conical profile, which may have a single axis of symmetry. It may have a rounded end. The tool may be made of metal.

Embodiments of the invention will now be described with reference to the figures of the drawings, in which;

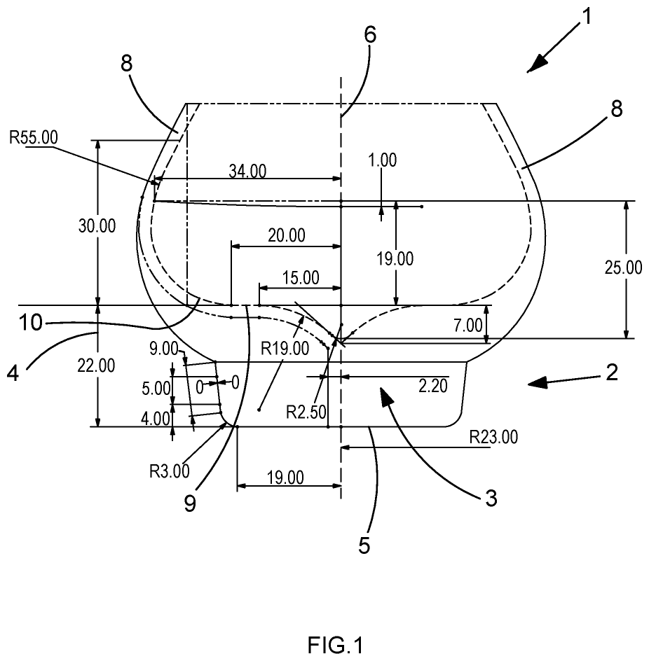

FIG. 1 shows a partial cross-sectional view of a lower portion of a glass according to an embodiment of the invention.

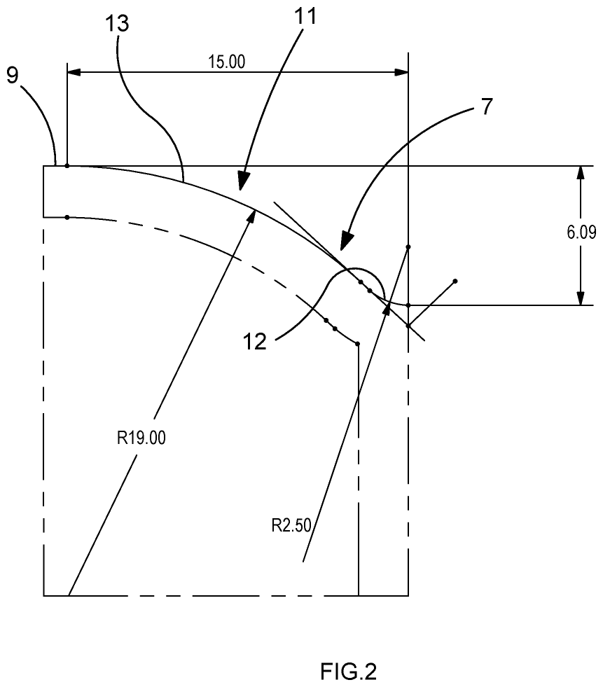

FIG. 2 shows an enlarged partial cross-sectional view of one half of the depression shown in FIG. 1.

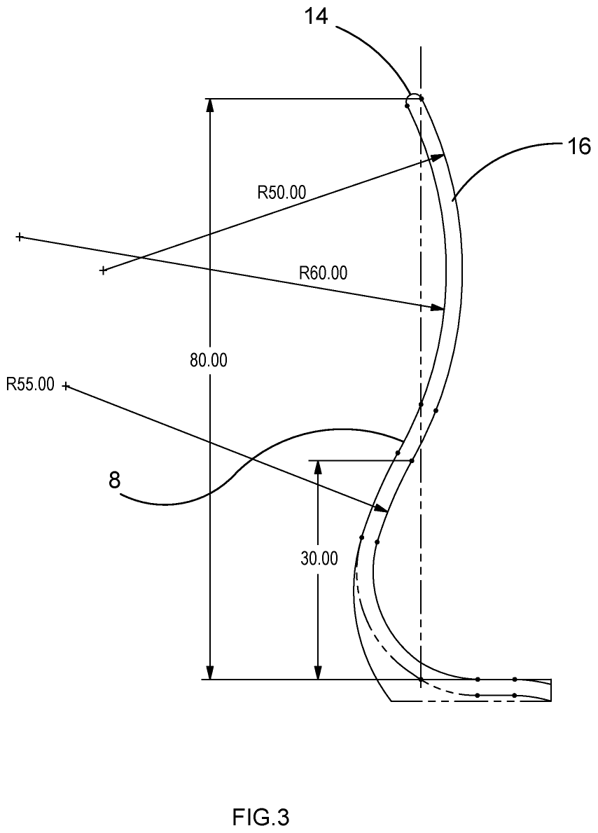

FIG. 3 shows a cross-sectional view of a portion of the sidewall of the embodiment shown in FIG. 1.

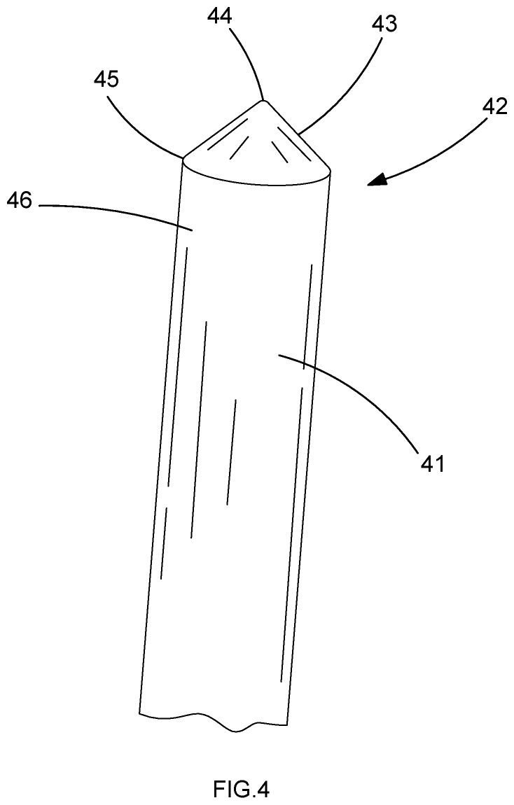

FIG. 4 shows a tool for use in a method according to the invention.

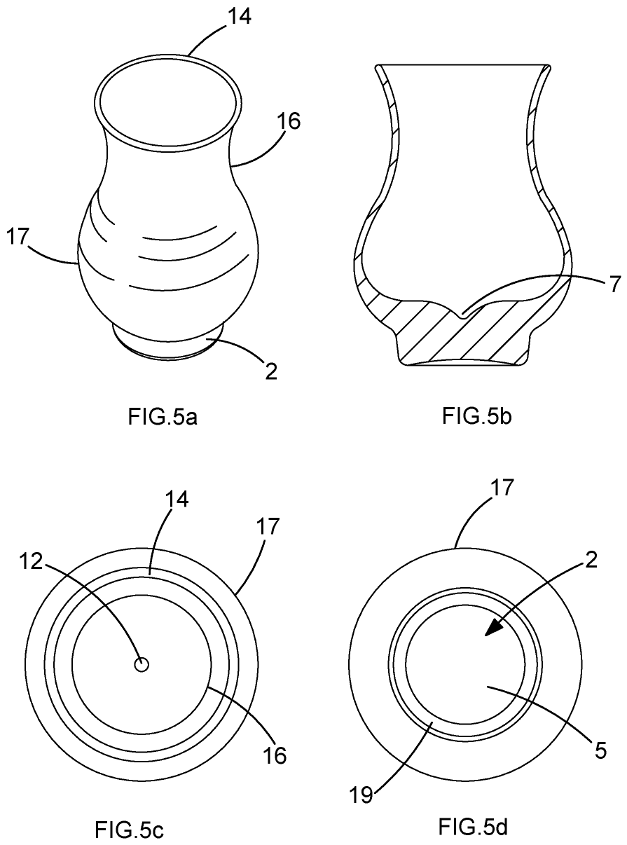

FIG. 5a shows a perspective view of a glass according to the invention. FIGS. 5b, 5c and 5d show a cross-sectional side view, a plan view and a view of the underside respectively of the glass shown in FIG. 5a.

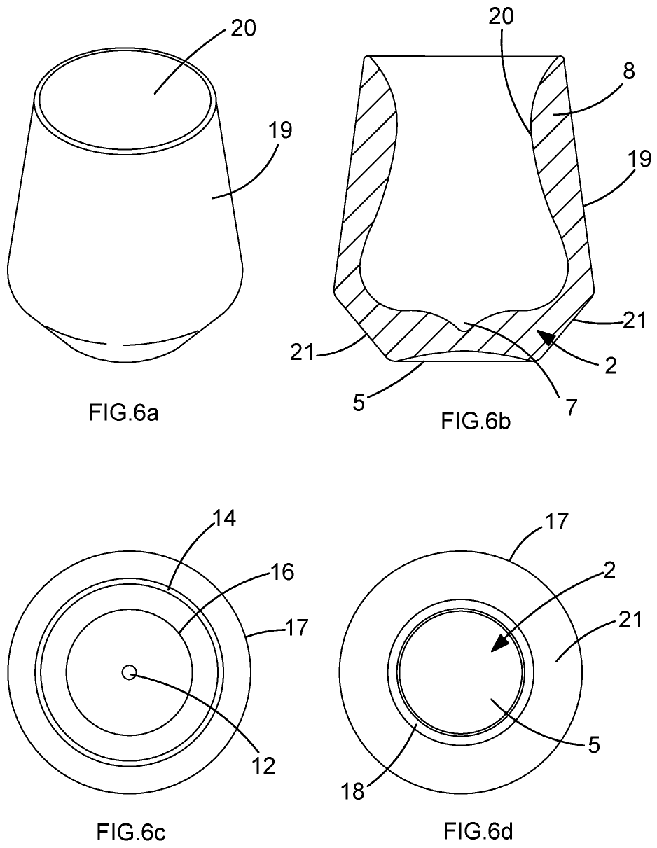

FIGS. 6a-6d, 7a-7d and 8a-8d show views which correspond to FIGS. 5a-5d, but for three further embodiments of the invention.

In the drawings, any dimensions shown are not intended to limit the scope of protection. Indeed, the drawings only show non-limiting embodiments of the invention.

FIG. 1 shows a partial cross-sectional view of a glass according to the invention having the following composition:

| | |
|---|---|
| Silicon dioxide | 73% |
| Sodium oxide | 15% |
| Boron trioxide | 2.5% |
| Calcium oxide | 5.5% |
| Zinc oxide | 2% |
| Aluminium oxide | 2% |

The glass 1 has a base 2 which comprises an ice 3. The thickness of the ice is 22 mm as shown by the dimension 4. This thickness is measured from the inner surface of the glass which defines the base at a portion which is generally horizontal to the bottom 5 of the glass. The ice creates a distance between a user's hand and liquid in the glass. It also provides a region of high heat capacity. These features both prevent heat from a user's hand from warming liquid in the glass.

The ice has a lower generally cylindrical portion with a flat bottom 5 to support the glass upon a surface. The generally cylindrical portion has a rounded lower edge. The generally cylindrical portion is flared outwardly to a wider diameter at its upper end, where it meets the rest of the base of the glass. The base of the glass has a conical shaped depression 7 located centrally in the base. The profile of the depression is shown in more detail in FIG. 2. The base of the glass merges into the sidewalls 8 of the glass.

The surface of the base 2 of the glass which defines the interior volume of the glass can be split into 3 portions. A first portion forms the depression 7. A second portion 9 is generally horizontal with respect to the bottom 5 of the glass. A third portion 10 curves upwardly from the second portion 9, to meet the sidewalls 8 of the glass. The second portion 9 is located between the first 7 and third 10 portions. The gradient of the base does not change abruptly. That is, the gradients of the first, second and third portions run together smoothly.

The glass has an axis of rotational symmetry 6 which is perpendicular to the bottom 5 of the glass. It has an infinite number of planes of symmetry around that axis.

The sidewalls 8 curve outwardly with a constant curve to form a bulb volume inside the glass. The sidewalls then converge towards a neck of the glass, which neck has a lower interior diameter than the bulb. The sidewalls then diverge, again with a constant curve until they terminate at an upper mouth. These features are shown in FIG. 3. The radius of the curvature of the sidewalls is 55 mm.

FIG. 2 shows an enlarged cross-sectional view of half of the depression in the base of the glass.

The depression 7 at its upper edges is connected to the flat and generally horizontal second portion 9 of the surface of the base. The width/diameter of the depression 7 is 30 mm. However, in some embodiments the width/diameter of the depression is 16 mm. The walls 11 of the depression have a lower rounded portion 12. In this embodiment the radius of the curvature of this portion is 2.5 mm. Between the lower curved portion and the second portion 9 of the depression 7 the sidewalls of the depression have a convex tangent curve 13 with a radius of curvature of 19-20 mm. The gradient of the walls of the depression 7 does not change abruptly. That is, the gradients of the lower rounded portion 12, the convex portion 13 and the second portion 9 run together smoothly. The depth of the depression measured from the generally horizontal second portion 9 of the base and the bottom of the lower rounded portion 12 is about 6 mm.

The radius of the curvature of the walls 11 of the depression 7 may be up to about 20 mm. The radius of curvature needs a radius large enough to allow the liquid to smoothly flow into the centre of the depression without creating a block or an air pocket, but not too large-preferably not above 20 mm—otherwise it will be too shallow to create the tornado effect that pushes the liquid towards the side walls effectively. The radius of the curvature of the walls of the depression is preferably above about 5 mm.

FIG. 3 shows a cross-sectional view of a sidewall of the glass shown in FIG. 1. The curvature of the sidewall 8 is continuous and tangent. It has a similar apex from the bulb to the rim 14. The sidewall is convergent upwards from the bulb's maximum diameter to the divergent curved portion which opens to the rim. The curve of the sidewall becomes divergent at ⅔ of the vessel height.

The curvature radiuses of the sidewalls are preferably between 50 and 60 mm.

However, the curvature of the curve which forms the bulb may vary if a larger bulb is needed. Preferably the curvature keeps a constant apex-a continuous, tangent exchange of curvatures with similar transitional radii around the sidewalls of the glass. This constant curve (apex) encourages motion and dispersion of the ethanol component of a liquid over a large area of the glass.

Upper portions of the sidewalls have a constant thickness. The upper portion in this embodiment starts from the maximum diameter of the bulb.

FIG. 4 shows a tool 41 for forming the depression in the glasses described herein.

The sidewalls and base of the glasses described herein may be formed from a molten/heated workable soda-lime composition. The composition is put into a mould and then blown to form the sidewalls and base of the glass.

The glass is then removed from the mould and a tool 41 is inserted through the mouth of the glass. A working end 42 of the tool is imprinted into the base inside the glass whilst the soda-lime material is still hot and malleable. The imprint left by the tool forms the depression in the base of the glass. The glass is then allowed to cool and solidify. The working end of the tool has a profile which generally corresponds to the shape of the depression which is left in the base of the glass.

Preferably the tool has a generally conical shape formed by sidewalls 43 which form an upper rounded tip 44. The transition portion 45, where the sidewalls 43 of the working end 42 meet the rest of the body 46 of the tool, comprises a rounded edge which runs around the tool. The features of the working end of the tool may correspond to any of the features of the depressions described herein in connection with embodiments of the invention. The body of the tool is generally cylindrical. The tool has a central axis of symmetry which runs parallel to its direction of elongation. The tool is made from metal.

In some embodiments, the following steps are used in the production:
1—Blow glass body and make the depression using the working end of the tool (for example the tool shown in FIG. 4) inside the glass.
2—Make stem & base.
3—Join stem and base with glass body.
4—Annealing.
5—Cutting the rim.
6—Grinding.
7—Cleaning & drying.
8—Bake the rim.

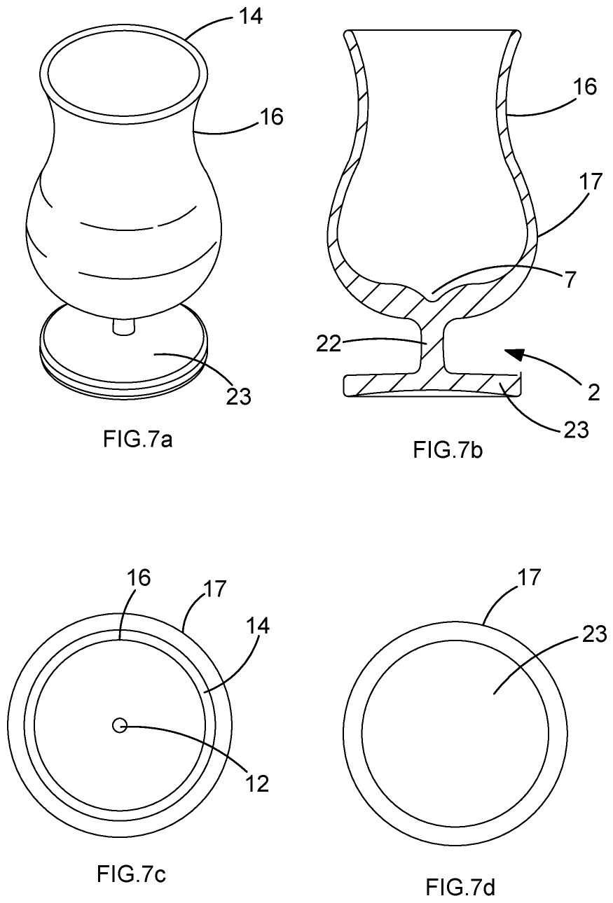

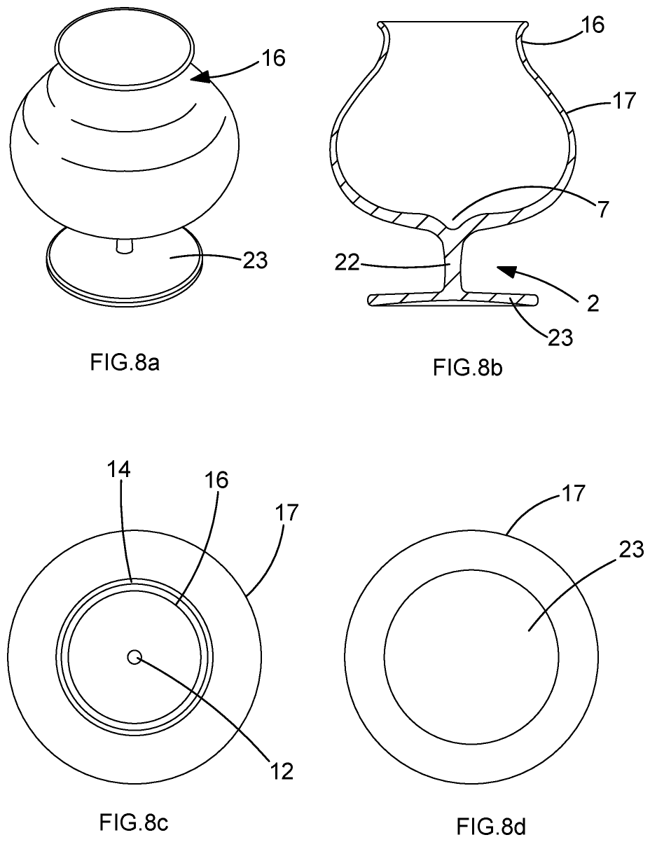

Steps 2 and 3 are only included for glasses which have a stem (for example the glasses shown in FIGS. 7 and 8).

FIGS. 5a-d show perspective, side cross-sectional, top and bottom views of a glass which is has a similar shape to the embodiment shown in FIG. 1. The rim 14 of the glass is circular. The sidewalls converge inwardly towards a neck 16 of the glass which has a smaller diameter than the rim. The neck prevents liquid from escaping the glass. From the neck the sidewalls diverge towards a lower maximum diameter 17 of the bulb. The sidewalls then converge towards the base 2. The depression 7 in the base is visible in the view 5b. The volume of the glass is 180 ml.

The lower rounded portion 12 of the base is visible in the plan view 5c, as is the rim, 14, the neck 16 and the maximum diameter of the bulb 17. The bottom 5 of the base 2 is shown in the underside view of FIG. 5d. The bottom 5 of the glass has a slight concave curvature over its central portion, which is bounded by a circular foot 18, but otherwise defines a generally horizontal plane.

This example has a 46 mm diameter at the top of the base 2, with angled vertical extraction. That is, the side walls of the base 2 taper inwardly and downwardly towards the foot 18. This allows for the very bottom of the glass—the foot 18—to have a better and softer grip to the hand.

FIGS. 6a-6d show a glass with a similar base and depression 7. The exterior surfaces 19 of the sidewalls 8 are straight sided over an upper portion of the glass. The interior surfaces 20 of the sidewalls are curved to have generally the same profile as the glass shown in FIGS. 5a-5d. The base 2 of the glass has straight sides 21 which converge from a maximum diameter towards the flat bottom 5 of the glass.

The lower rounded portion 12 of the base is visible in the plan view 6c, as is the rim, 14, the neck 16 and the maximum diameter of the bulb 17. The bottom 5 of the base 2 is shown in the underside view of FIG. 6d. The bottom 5 of the glass has a slight concave curvature over its central portion, which is bounded by a circular foot 18, but otherwise defines a generally horizontal plane.

FIGS. 7a-7d and 8a-8d show a glass with a similar depression 7 in the base 2 of the glass. The glass shown in FIGS. 7a-7d has a volume of 175 ml. The bases in these two embodiments both comprise a stem 22 and a foot 23. The sidewalls of these glasses each diverge from the base 2 to a maximum diameter bulb 17. The sidewalls then converge inwardly to a neck 16 and back outwardly to a rim 14. The lower rounded portions 12 of the bases are visible in the plan views 7c and 8c.

### Testing

A glass of the type shown in FIG. 5 was tested using whiskey against some conventional types of tasting glass. The glasses against which the FIG. 5 glass was tested were; a rocks glass, a tumbler, a Glencairn glass, and a Norlan glass. Apart from the Norlan glass, these glasses were all made of crystal glass. The Norlan glass was made of Borosilicate glass.

Tester feedback on the glass according to the invention when compared with the other glasses on test was as follows:
“excellent, really really little ethanol, straight into the whiskey”
“that's what I was looking for-a different league straight away”
“definitely more concentrated, so you get all the smells and all the concentrates of everything that's been put in there”
“very smooth intake of the whiskey [nose]”.

1. A glass comprising:
sidewalls and a base which define a volume for accommodating a liquid,
wherein a depression is formed in the base,
and wherein the glass is formed from soda-lime glass.

2. A glass according to claim 1 wherein the depression is generally conical.

3. A glass according to claim 1 wherein the depression has a symmetry axis which is perpendicular to the base.

4. A glass according to claim 1 wherein a volume defined by the depression is between 0.5 ml and 3 ml.

5. A glass according to claim 1 wherein a volume defined by the depression is less than 1 ml.

6. A glass according to claim 1 wherein a depth of the depression is between 6 mm and 10 mm.

7. A glass according to claim 1 wherein the depression is formed by sidewalls in the base which have a constant curvature.

8. A glass according to claim 1 wherein the base comprises an ice having a thickness of between 20 mm and 50 mm.

9. A glass according to claim 1 wherein the sidewalls form a bulb.

10. A glass according to claim 1 wherein the sidewalls have a convergent portion and a divergent portion, wherein the divergent portion forms a mouth of the glass.

11. A glass according to claim 1 wherein a curvature radii of the sidewalls are between 50 mm and 60 mm.

12. A glass according to claim 1 wherein the glass comprises 65-75 percent silicon dioxide, 10-20 percent sodium oxide, and 2-16 percent calcium oxide.

13. A method of forming a glass according to claim 1 comprising the steps of:
forming the sidewalls and base of the glass from a heated soda-lime composition, and forming the depression in the base of the glass by imprinting the working end of a tool into the base of the glass.
